(19) United States
(12) Patent Application Publication
(10) Pub. No.: US 2008/0288630 A1
(43) Pub. Date: Nov. 20, 2008

(54) DEVICE MANAGEMENT

(75) Inventors: Vincent Merat, La Riviere-de-Corps (FR); Alan B. Bok, Naperville, IL (US); Soodesh Buljore, Bures-sur-Yvette (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/750,381

(22) Filed: May 18, 2007

(51) Int. Cl. G06F 15/173

(52) U.S. Cl. 709/224

(57) ABSTRACT

A device, such as a mobile phone, comprises a management tree store (101) which stores an Open Mobile Alliance Device Management (OMA DM) management tree. A tree processor (103) is arranged to detect a change associated with at least a first node of the management tree. A backup node processor (107) adds a first backup node as a child node of the first node in response to the detection of the change. The backup node comprises backup data representing a setting for the first node prior to the change. A restore processor (109) is arranged to restore at least part of the management tree to a setting prior to the change in response to a retrieval of the backup data from the first backup node. The invention may facilitate/improve backup and restore operations for OMA DM devices.

### FIELD OF THE INVENTION

The invention relates to device management and in particular to device management using an Open Mobile Alliance Device Management management tree.

### BACKGROUND OF THE INVENTION

In recent years, the number and variety of personal electronic devices available to the average consumer has increased substantially. For example, a user may currently own a mobile phone, a personal computer, a Personal Digital Assistant (PDA) etc. Furthermore, the existence of different devices within individual systems is increasing and for example cellular communication systems typically support a large number of different types of mobile phones from a large number of different manufacturers.

Accordingly, device management is becoming increasingly important yet difficult. Device management may relate to configuring of the device, detecting faults of the device, storing information etc.

For example, configuring a device can be complicated due to the complexity of typical devices and e.g. the large number of variables involved. Specifically, network parameters are different for different phones, user interfaces may be different and different systems and manufacturers may require different configurations.

In many systems it is desired that the device management can be fully or partially controlled by a centralized device management server thereby facilitating operation by the user and allowing the network operator to retain control. In order to achieve such remote device management a number of dedicated and proprietary device management systems have been developed. However, in order to achieve facilitated operation in heterogeneous systems and to facilitate interoperability, a standards body known as the Open Mobile Alliance (OMA) has developed an open standard for device management.

Specifically, the Open Mobile Alliance has developed a Device Management specification known as OMA DM (Open Mobile Alliance Device Management). The OMA DM specification is designed for management of small mobile devices such as mobile phones, PDAs and palm top computers. The device management is intended to support e.g. the following typical uses:
Provisioning—Configuration of the device (including first time use), enabling and disabling features.
Configuration of Device—Allows changes to settings and parameters of the device.
Software Upgrades—Provides for new software and/or bug fixes to be loaded on the device, including applications and system software.
Fault Management—Reports errors from the device, query about the status of device

All the above functions are supported by the OMA DM specification, and a device may optionally implement all or a subset of these features. Since the OMA DM specification is aimed at mobile devices, it is designed with sensitivity to the following:
Small foot-print devices, where memory and storage space may be limited.
Bandwidth of communication could be constrained, such as for wireless connectivity.
Tight security, as the devices are vulnerable to virus attacks and the like; authentication and challenges are made part of the specifications.

The OMA DM specification uses XML (eXtended Markup Language) for data exchange and more specifically uses a sub-set defined by SyncML (Synchronization Markup Language). The device management takes place by communication between a server (which is managing the device) and the client (the device being managed).

The communication protocol is a request-response protocol. Authentication and challenge of authentication are built-in to ensure the server and client are communicating only after proper validation.

However, although the OMA DM specification provides a practical solution it also has some disadvantages.

Specifically, the functionality provided for backup and restoring of OMA DM information in the device requires that the information is stored centrally in the device management server and transmitted to the device when required. For example, the OMA DM specification relies on each device implementing an OMA DM management tree which is an organized hierarchical data structure comprising the OMA DM information. However, if information of this tree is locally corrupted the only means of restoring the management tree is to obtain replacement information from the central device management server. However, this is complex and cumbersome and increases the computational and communication resource requirement. Indeed, it not only requires that information is provided to the device during a restore operation but also requires the device to continuously transmit information that may need to be restored to the centralized device management server. It is impractical to frequently communicate such information and in most systems this results in any restore operation returning the device to a significantly earlier state or even to the original configuration.

Hence, improved device management would be advantageous and in particular an OMA DM device management system allowing increased flexibility, improved backup and/or restore operations, reduced resource requirements, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a device comprising: means for storing an Open Mobile Alliance Device Management, OMA DM, management tree; detection means for detecting a change associated with at least a first node of the management tree; backup means for adding a first backup node as a child node of the first node in response to the detection of the change, the backup node comprising backup data representing a setting for the first node prior to the change; restore means arranged to restore at least part of the management tree to a setting prior to the change in response to a retrieval of the backup data from the first backup node.

The invention may provide improved backup and/or restore functionality for an OMA DM device. In particular, the invention may allow an OMA DM device to be restored to a previous setting based on information held locally. The organisation of backup information within the OMA DM tree may allow particular advantages and may for example facilitate compatibility with other device management functionality, allow an automatic and structured generation and/or retrieval of backup data. For example, OMA DM/SyncML compatible commands and operations may be used to restore a device to a previous configuration without requiring upload of data to, or download of data from, a remote centralised server. Backup data generation, storage and/or retrieval operations may be facilitated by the invention. In particular, by storing backup data for the individual OMA DM node as a child node of that node, the backup generation, storage and retrieval operations may be based on OMA DM operations on that node. In particular, a simple restoration of an OMA DM node or sub-tree of that node may be achieved simply by executing restore operations for that node.

The first node may be an interior node of the OMA DM management tree or may be a leaf node of the OMA DM management tree. The backup data may relate to e.g. parameter data held by the first node, a node dependency structure (e.g. a child node or child sub-tree) depending from the first node. Similarly, the restore means may restore the management tree to a setting prior to the change by changing one or more parameter values of the first node and/or a node depending from the first node (either directly depending or depending via intermediate nodes/hierarchical layers) and/or by adding or deleting nodes in a sub-tree depending from the first node.

The OMA DM management tree may specifically be a SyncML management tree.

The addition of the first backup node may correspond to a modification of an existing backup node (corresponding to a deletion of the existing backup node followed by an addition of a new backup node comprising the backup data for the current change in addition to all data of the existing backup node).

According to another aspect of the invention there is provided a method of operation for a device, the method comprising: providing an Open Mobile Alliance Device Management, OMA DM, management tree; detecting a change associated with at least a first node of the management tree; adding a first backup node as a child node of the first node in response to the detection of the change, the backup node comprising backup data representing a setting for the first node prior to the change; and restoring at least part of the management tree to a setting prior to the change in response to a retrieval of the backup data from the first backup node.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a device in accordance with some embodiments of the invention;

FIG. 2 illustrates an example of an OMA DM management tree in accordance with some embodiments of the invention;

FIG. 3 illustrates a flowchart of a backup operation in accordance with some embodiments of the invention;

FIG. 4 illustrates a flowchart of a restore operation in accordance with some embodiments of the invention; and

FIG. 5 illustrates an example of a method of operation of a device in accordance with some embodiments of the invention.

### DETAILED DESCRIPTION OF SOME EMBODIMENTS OF THE INVENTION

The following description focuses on embodiments of the invention applicable to a device management in accordance with the OMA DM specifications and in particular to an OMA DM mobile phone of a cellular communication system. However, it will be appreciated that the invention is not limited to this application but may be applied to many other OMA DM devices including for example laptop computers or PDAs.

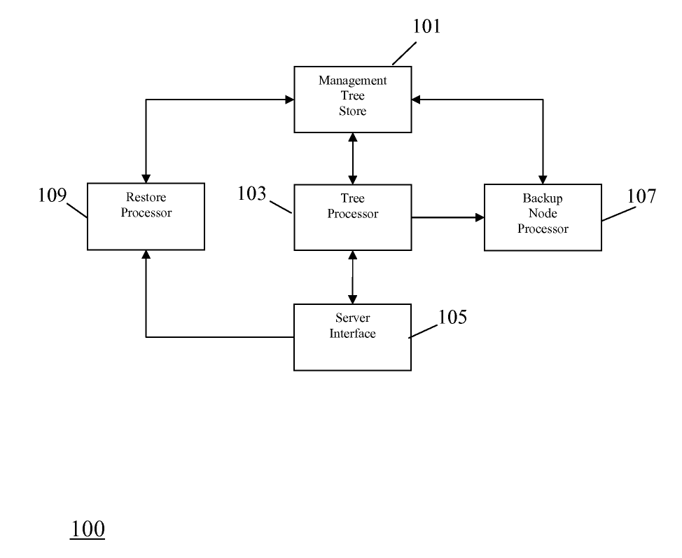

FIG. 1 illustrates a device in accordance with some embodiments of the invention. In the specific example, the device is an OMA DM mobile phone.

The mobile phone comprises a management tree store 101 wherein the OMA DM management tree for the mobile phone is stored. The management tree store 101 is coupled to a tree processor 103 which is operable to manage the management tree. The tree processor 103 is coupled to a server interface 105 which is operable to communicate with a remote OMA DM server. The server interface 105 communicate with the remote OMA DM server via a communication network and may for example comprise a transceiver capable of communicating with a base station over the air interface of the cellular communication system thereby supporting communication between the mobile phone and an OMA DM server located in the fixed network of the cellular communication system.

Specifically, the OMA DM server can transmit OMA DM commands to the mobile phone where they are provided to the tree processor 103. The tree processor 103 can then modify the tree in accordance with the commands (such as add nodes, delete nodes, change node parameter values etc) or can e.g. retrieve requested data and transmit this back to the OMA DM server. The OMA DM commands may specifically be SyncML commands as the OMA DM specification has been developed to use/include the SyncML language.

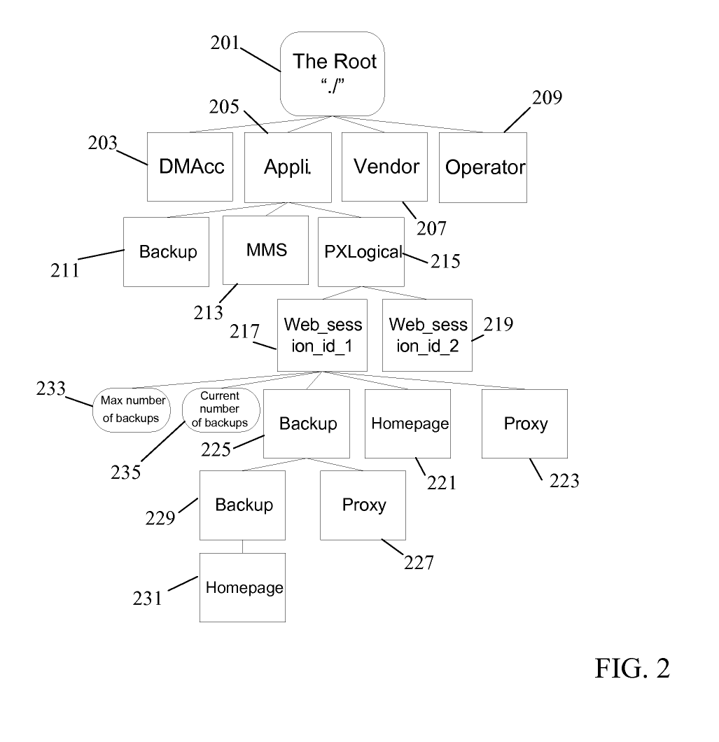

FIG. 2 illustrates an example of an OMA DM management tree in accordance with some embodiments of the invention. In an OMA DM system, the device configuration data is organized in a hierarchical structure called a management tree. Sub-trees are called device management nodes and a leaf, usually a single configuration parameter, is called a manageable object. The DM tree is essentially mapped to permanent or dynamic objects as an addressing schema to manipulate these objects. Permanent objects are objects that are built into the device when it was manufactured and typically cannot be deleted. Dynamic objects are items that can be added or deleted (e.g. ring-tones or wallpaper).

As illustrated in FIG. 2, the highest layer of the OMA DM management tree consists of only the Root node 201. In the example, the root node has four nodes corresponding to different aspects of the device management. Specifically, a DMAcc node 203 is the root node for a sub-tree comprising information related to Device Management account settings (authentication, encryption, . . . ) needed for the interaction between the DM client and the DM server; an application node 205 is the root node for a sub-tree comprising information related to configuration of applications on the mobile phone; a vendor node 207 is the root node for a sub-tree comprising information related to vendor controlled/specific configuration data and an operator node 203 is the root node for a sub-tree comprising information related to operator controlled/specific configuration data.

The application node 205 has a child node for each OMA DM application. In the example, three applications each have a root node for configuration data depending from the application node 205, namely a node 211 exists for a dedicated backup application (named backup), a node 213 exists for a Multimedia Messaging Service application (named MMS) and a node 213 exists for a proxy web browsing application (named PXLogical).

Each of these nodes has a sub-tree comprising the OMA DM configuration data for the application. For clarity and brevity, FIG. 2 only illustrates a subset of nodes of the sub-tree of the PXLogical node 213.

Specifically, the PXLogical node 213 has a first child node 217 corresponding to a first web identity that may be used for the application and a second child node 219 corresponding to a second web identity that may be used for the application.

For the first web identity, the OMA DM management tree furthermore comprises information of the homepage and proxy that should be used by the application. Thus the first identity node 217 has a leaf child node 221 for the homepage parameter and a leaf child node 223 for the proxy parameter.

In the mobile phone of FIG. 1, the tree processor 103 is arranged to continuously monitor whether any changes occur in the management tree. For example, the OMA DM server may transmit a SyncML DEL command resulting in a node being deleted, a SyncML REPLACE command resulting in a parameter value of a leaf node changing etc. Also, the tree processor 103 may detect the modification to the tree in response to a user action such as a user input provided via the user interface of the mobile phone.

The device of FIG. 1 comprises functionality for automatically backing up the OMA DM management tree within the management tree itself thereby allowing changes to be undone and a previous version of the management tree being restored following a data corruption. Specifically, the management tree store 101 is coupled to a backup node processor 107 which is further coupled to a tree processor 103. When the tree processor 103 detects a change relating to a first node occurring in the management tree, it informs the backup node processor 107 of this change. In response, the backup node processor 107 proceeds to generate a backup node as the child of the affected node(s).

Specifically, the backup node processor 107 creates a new node for the first node with the backup node comprising backup data that represents a setting for the first node prior to the change. The backup data may for example reflect a previous parameter value or may represent the structure of the management tree prior to the change. In some examples, the backup data may represent an entire sub-tree of the first node following a deletion of a child node of the first node.

It will be appreciated that in some embodiments only some changes may result in a backup node being generated. For example, the node processor 103 may evaluate the changes and may only backup some changes such as deletions or parameter value changes whereas other changes (such as copying) may not be backed up. As another example, backup nodes may only be generated for some nodes of the OMA DM management tree. For example, for each node an attribute may indicate whether changes to the node should be backed up or not. E.g. a node comprising data indicating a time lapsed since the mobile phone was switched on may not need to be backed up. In such examples, the tree processor 103 can determine if the detected change belongs to a set of changes that should be backed up and if not no new backup node is created.

In the example of FIG. 2, the tree processor may detect that a SyncML command is received which changes the proxy used by the first web session identity, i.e. that a command is received which changes the value of the proxy leaf node 223. The change of leaf node 223 also constitutes a change for the first identity node 217 as a given node is representative of all values from sub-trees depending from that node. Thus a change to a node may also be considered to be a change for all parent nodes of that node i.e. a change of all nodes at higher hierarchical nodes for which the node is a dependent node (directly or via intermediate nodes).

The backup node processor 107 is informed of this change and in response it proceeds to generate a new backup node 225 which is a child of the first identity node 217. The backup node processor 107 may also generate a backup node for the proxy node 223 and add this as a child node of the proxy node 223.

The backup node 225 furthermore has a proxy backup child node 227 for the backup data representing the previous proxy value that was stored in the proxy node 223. Thus, the backup node 225 comprises backup data representing the setting prior to the change in the form of a child leaf node 227.

Accordingly, if the mobile phone of FIG. 1 at a later stage needs to be restored to the previous value prior to the change (for example if the provided proxy data is invalid, the new proxy is not operational or a data corruption occurs), the OMA DM management tree structure can be restored without requiring any external communication or data. Specifically, the mobile phone comprises a restore processor 109 which can restore at least part of the management tree to a setting prior to the change in response to a retrieval of the backup data from the first backup node. Specifically, the restore processor 109 can in response to simple SyncML commands restore the previous setting. In the specific example, the restore processor 109 may simple retrieve the data of the proxy backup node 227 in response to a SyncML GET command specifying this node. It may then restore the previous value of the proxy node 223 in response to a SyncML REPLACE command specifying this node and the backup data retrieved from the backup proxy node 227. The restore processor 109 may then delete the backup node 225 as a child of the first session identity node 217.

The described system provides an efficient, practical, low complexity and high performance means of providing automatic backup and restore functionality for an OMA DM management tree in an OMA DM device. The backup functionality and data storage is embedded within the management tree itself thereby providing an efficient and practical way of generating, storing and retrieving backup data as well as facilitating restore operations. For example, a given node or substructure can be restored in isolation simply be using the data embedded within this structure. Furthermore, familiar OMA DM approaches and commands are automatically applicable to the backup and restore operations. For example, conventional OMA DM authentication principles can be used to ensure that restoring is only performed in response to requests or commands from authenticated OMA DM servers.

Thus, the described functionality provides a mechanism for storing the history of tree changes and for restoring the tree to a previous version. E.g., if a problem with the settings is detected, the mobile phone is able to restore the previous working configuration (if any) by itself. The problem resolution will be faster and simpler than for prior art approaches as no interaction with an external server is necessary.

The approach uses new backup nodes in the management tree to store the backup data in the management tree itself. Specifically, a special node containing the backup information is introduced to each node that should be backed up.

As a specific example of a change that may be restored is a deletion of child node of a specific node. In this case a backup node is added to the parent node. The backup node may contain information of not only the child node which was deleted but also of the nodes that are dependent on this node, i.e. the child nodes of the child node, the child nodes of these nodes etc. Thus, the backup node may comprise part of or the whole of the sub-tree which depends from the deleted child node. The backup node may comprise this information within itself or may comprise it via a sub-tree comprising nodes which depend from the backup node. For example, a backup node may be created for the parent node when the child node is deleted and the entire sub-tree of the child node and all nodes depending therefrom may be attached to this backup node.

Thus, in the system, changes to nodes at lower hierarchical layers may also be backed up at the higher layers by parent nodes (or parents of parents etc). E.g. if a change occurs to a first node which is part of a sub-tree that is attached to a second node at a higher hierarchical level, a new backup node may be added to the second node reflecting the change to the first node. Thus, the new backup node is added as a child node of the second node and may specifically comprise backup data which represent a setting for the first node prior to the change. In addition, the backup node may comprise a location indication for the first node in the sub-tree. For example, the backup data may comprise the URI (Uniform Resource Identifier) of the first node as well as the setting prior to the change.

It will be appreciated that although the above description focuses on the backup of a single change to a node of the OMA DM management tree, the approach can be applied to the backup and restore of a plurality of sequential changes.

Thus, the mobile phone may store backup data for a plurality of changes for a given node by adding a new backup node for each change. In the example, the backup node processor 107 creates a new backup node for each new change and comprises the backup data representing this change in the node (either in the node itself or as a depending node sub-tree comprising one or more hierarchical layers). Any already existing backup node being a direct child of the node is then moved from being a child node of the changed node to being a child of the new backup node.

For example, for the management tree of FIG. 2 there may initially be no backup information stored for the first web identity, i.e. the first session identity node 217 initially does not have any dependent backup nodes. The home page for the first web identity may then be changed and in response a new homepage backup node 229 may be generated as a direct child of the first session identity node 217. The homepage backup node comprises backup data indicating the homepage prior to the change, e.g. as a child leaf node 231 of the homepage backup node 229.

Subsequently, the proxy for the first web identity may be changed and as previously described a proxy backup node 225 may be created as a child of the first session identity node 217. The backup node 225 comprises backup data representing the proxy setting prior to the change in the form of a child leaf node 227. Furthermore, the homepage backup node 229 is changed from being a child of the first session identity node 217 to being a child of the new proxy backup node 225. Thus, the structure illustrated in FIG. 2 is achieved.

The restore processor 109 may use this information to undo a plurality of changes and restore the management tree to an earlier version. Specifically, the restore processor 109 may sequentially restore the node in response to backup data of a requested number of dependent backup nodes. For example, for the tree of FIG. 2, two changes may be undone by the restore processor 109 first retrieving the information from the child node of the first session identity node 217, i.e. it may retrieve the previous proxy setting from the backup node 225 and the child leaf node 227. It may then restore the proxy setting of the first session identity node 217 by setting the proxy value of the proxy leaf node 223 to the retrieved value. It may then move the homepage backup node 229 from being a child of the proxy backup node 225 to being a child of the first session identity node 217. The proxy backup node 225 is then deleted thereby restoring the management tree to the status prior to the latest change.

The restore operation may then be iterated a second time resulting in the homepage backup data being retrieved from the homepage backup node 229 which is now a direct child of the first session identity node 217. The value of the homepage leaf node 221 is then set to the retrieved value and the homepage backup node 229 is deleted (after any children backup nodes have been moved to be child nodes of the first session identity node 217). In this way the restore processor 109 may undo the last two changes. It will be appreciated that this approach may easily be extended to any number of changes.

In some embodiments, the backup depth for each node (i.e. the number of previous changes for which backup data is stored) is controlled by attributes of the node. Specifically, nodes that may be backed up can comprise a first attribute representing a maximum number of backup nodes which may depend from the first node. Thus, the first attribute can limit the number of sequential backup nodes that can be attached to a given node to a given value. For example, for an attribute value of N, a string of N backup nodes (with each backup node being the child of the backup node for the subsequent change) may be stored. Thus, the attribute represents the number of changes that can be undone/ restored.

Each node may have a second attribute representing the current number of backup nodes which depend from the first node, i.e. it represents the current number of changes for which backup data is stored for the given node.

In the example of FIG. 2, the first session identity node 217 comprises a first attribute 233 indicating the maximum number of backup nodes and a second attribute 235 indicating the current number of backup nodes. In the example, the value of the second attribute would be two as two backup nodes 225, 229 depend from the first session identity node 217.

Whenever, a new backup node is created, the backup node processor 107 increments the second attribute. If the current number of backups (i.e. the second attribute) is equal to the maximum number of attributes (i.e. the first attribute) prior to the backup of the current change, the backup node processor 107 first deletes the earliest backup node depending from the node, i.e. the backup node at the lowest layer, before creating the new backup node as a child of the node being backed up and with the previous child backup node being made a child of the new backup node. The second attribute is thus maintained equal to the first attribute and the stored backup data is limited to the desired number of changes that may be backed up.

In some embodiments, restore operations may be automatically initiated by the restore processor 109. For example, the restore processor 109 may comprise functionality for performing a validity check of data stored in the management tree (e.g. using a checksum) and if invalid/corrupted data is detected the restore processor 109 may attempt to restore the associated nodes.

In some embodiments, the device may comprise means for providing a user input and the restore operation may be initiated in response to a user input. For example, the user interface of the mobile phone may be used by a user to directly initiate a restore operation.

In some embodiments, the restore processor 109 can initiate restore operations in response to commands received from the remote OMA DM server. Specifically, the server interface 105 can receive a restore command from the remote server and forward this to the restore processor 109.

In some embodiments, the restore operation may be controlled by a sequence of OMA DM/SyncML commands which read one or more of the backup nodes and writes the retrieved data to the associated parent nodes.

It will be appreciated that the tree processor 103 can use any suitable method of detecting a change to the management tree 103. In the specific example, the tree processor 103 continuously monitors the SyncML commands for the tree and detects if any write operations are performed. Specifically, the tree processor 103 determines that a change is made to the tree if an OMA DM/SyncML ADD/REPLACE/DELETE or COPY command is executed. If the command is associated with a node which is set to be backed up, the backup node processor 107 is informed resulting in the change being backed up.

The device of FIG. 2 is arranged to support new commands suitable for the backup and restore operations. These commands may specifically correspond to SyncML commands thereby facilitating design, development and operation of the system.

Currently, all SyncML commands have the following syntax:

COMMAND_NAME (node_URI) :
COMMAND_NAME (node_URI?list=<attribute>)

where the COMMAND_NAME can be GET, ADD, REPLACE, DELETE, COPY and the <attribute> value further specifies the required action from a limited set of possible values. For example, for the GET command, the <attribute> value can be “Struct”, “StructData” and “TNDS”

In the described system, the mobile phone is furthermore arranged to support a new attribute indicating that a backup operation is required. Specifically, for the GET command, the <attribute> may also take on the value of “backup”.

Thus, in response to a GET command specifying a specific node and having an attribute of “backup”, the mobile phone retrieves the backup data for the specified node.

Similarly, in response to receiving a REPLACE command specifying a specific node and having an attribute of “backup”, the mobile phone performs a restore operation of that node by retrieving the backup data for the node and writing it to the node.

Furthermore, the mobile phone of FIG. 1 is arranged to support SyncML commands which have an additional parameter value. Thus, the mobile phone supports commands with the following syntax:

COMMAND_NAME (nodeURI?list=<attribute>&<parameter>=
<parameter value>)

This new syntax allows additional parameters to be provided with valid parameter values depending on the command attribute.

Specifically, the parameter value may indicate the number of backup steps which should be processed by the command. Thus, for a GET command it specifies how many levels of backup nodes data should be retrieved for and for the REPLACE command it specifies how many changes should be undone.

Thus, the mobile phone supports new OMA DM/SyncML compatible commands aimed at backup and restore operations and in particular it supports the following commands:

```
GET (nodeURI?list=backup&depth=X) which
defines a new command attribute: backup. This
attribute is used for retrieving backup data
linked to the node specified by “nodeURI”.
Since many hierarchically organized backup
nodes may exist for a given node, the “depth”
parameter is used to specify the backup that
is required. If X=1, the latest backed up
data is retrieved.
The associated XML tag is given by:
<Get>
  <CmdID>4</CmdID>
  <Item>
    <Target>
      <LocURI>./A?list=backup&depth=1
    </LocURI>
    </Target>
  </Item>
</Get>
REPLACE (nodeURI?list=restore&depth=X) which
includes a new command attribute to the
replace command: restore. This attribute is
used for restoring the backup to a level
specified by the depth parameter.
The associated XML tag is given by:
<Replace>
  <CmdID>4</CmdID>
  <Item>
    <Target>
      <LocURI>./A?list=restore&depth=
    1</LocURI>
    </Target>
  </Item>
</Replace>
```

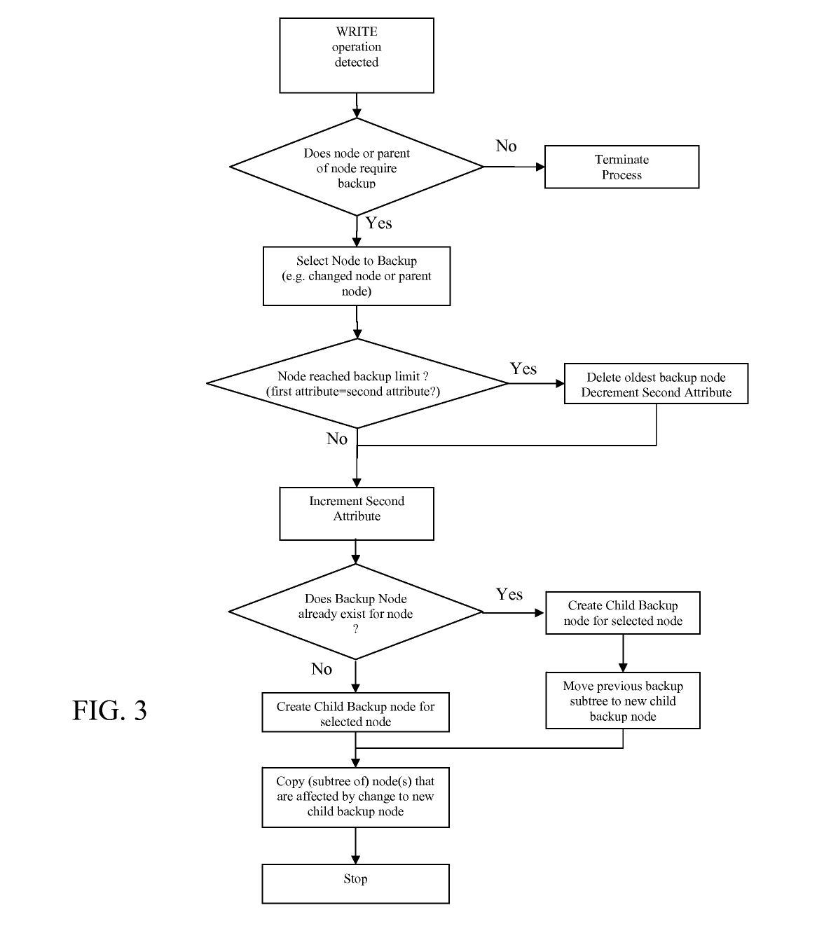

FIG. 3 illustrates a flowchart of a backup operation performed by the mobile phone of FIG. 1. In the example, this operation is performed every time a WRITE operation is executed on the management tree where a WRITE operation is an operation resulting from one of the following SyncML commands: ADD, REPLACE, DELETE and COPY.

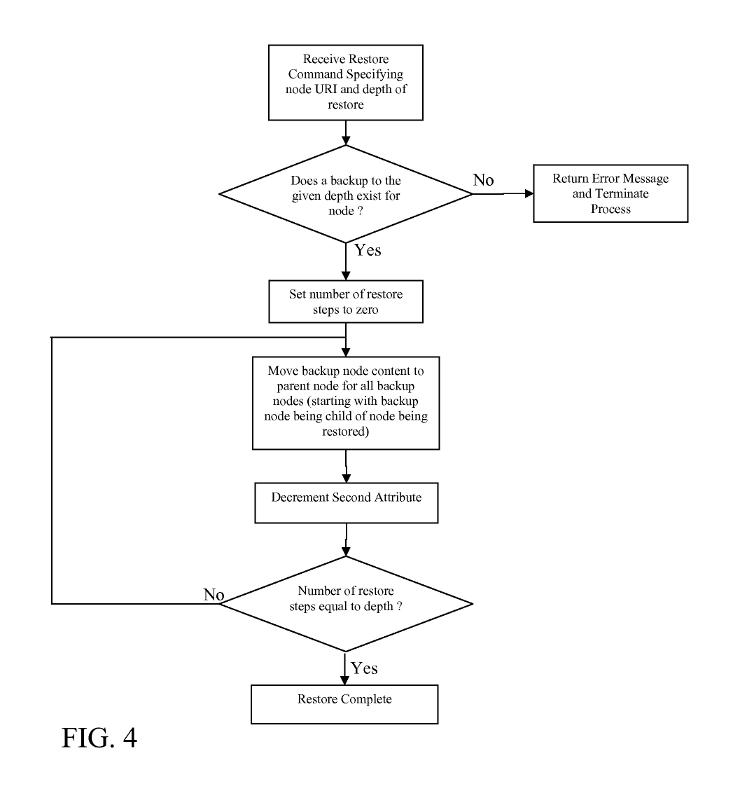

FIG. 4 illustrates a flowchart of a restore operation performed by the mobile phone of FIG. 1. The process is triggered by either a command coming from a remote OMA DM server or generated by a user interaction with the user interface of the mobile phone. The process may also be used as part of a rollback mechanism when an error occurs while performing a set of write operations on the management tree.

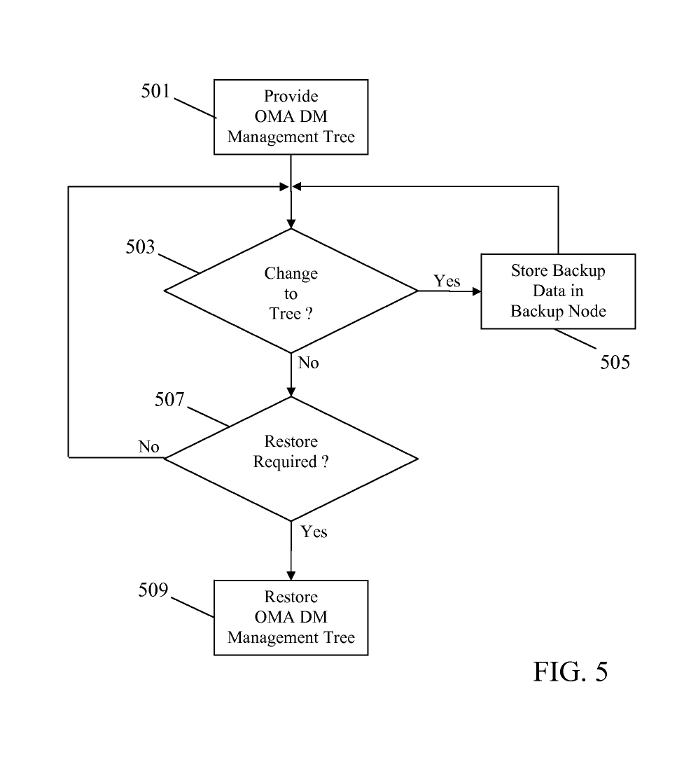

FIG. 5 illustrates an example of a method of operation for a device in accordance with some embodiments of the invention.

The method initiates in step 501 wherein an Open Mobile Alliance Device Management, OMA DM, management tree is provided.

Step 501 is followed by step 503 wherein it is detected whether there has been a change associated with at least a first node of the management tree.

If so, the method proceeds in step 505 wherein a first backup node is added as a child node of the first node in response to the detection of the change. The backup node comprises backup data representing a setting for the first node prior to the change.

If not, the method proceeds in step 507 wherein it is evaluated if a restore operation should be performed. If not, the method returns to step 503.

If so, the method proceeds in step 509 wherein at least part of the management tree is restored to a setting prior to the change in response to a retrieval of the backup data from the first backup node.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A device comprising:
means for storing an Open Mobile Alliance Device Management, OMA DM, management tree;
detection means for detecting a change associated with at least a first node of the management tree;
backup means for adding a first backup node as a child node of the first node in response to the detection of the change, the backup node comprising backup data representing a setting for the first node prior to the change;
restore means arranged to restore at least part of the management tree to a setting prior to the change in response to a retrieval of the backup data from the first backup node.

2. The device of claim 1 wherein the change is a change of value of a parameter of the first node and the backup data comprises a parameter value of the parameter prior to the change.

3. The device of claim 1 wherein the change is a deletion of a child node of the first node and the backup data comprises data representing at least part of a sub-tree having the child node is a root node prior to the change.

4. The device of claim 1 wherein the change is an addition of a child node to the first node and the backup data comprises data representing the absence of the first node.

5. The device of claim 1 wherein the backup means is arranged to move an existing backup node of the first node from being a child node of the first node to being a child node of the first backup node.

7. The device of claim 1 wherein the first node comprises a first attribute representing a maximum number of backup nodes depending from the first node and an attribute representing a current number of backup nodes depending from the first node; and the backup means is arranged to increment the second attribute in response to the addition of the first backup node.

8. The device of claim 7 wherein the backup means is arranged to delete an earliest backup node depending from the first node in response to a detection that the second attribute exceeds the first attribute following an increment and for setting the second attribute equal to the first attribute.

9. The device of claim 1 wherein the backup means is arranged to add a backup node as a child node of a root node for a sub-tree including the first node in response to the detection of the change, the backup node comprising backup data representing a setting for the first node prior to the change and a location indication for the first node in the sub-tree.

10. The device of claim 1 further comprising user input means for receiving a user input and wherein the restore means is arranged to restore at least part of the management tree in response to a user input.

11. The device of claim 1 further comprising command means for receiving command messages from a remote Open Mobile Alliance Device Management, OMA DM, server and wherein the restore means is arranged to restore at least part of the management tree in response to receiving a restore command from the remote OMA DM server.

12. The device of claim 1 wherein the detection means is arranged to detect the change in response to a detection of the device processing an OMA DM command selected from the set consisting of an ADD command, a REPLACE command, a DELETE command and a COPY command.

13. The device of claim 1 wherein the restore means is arranged to retrieve the backup data in response to receiving an OMA DM GET command specifying the first node and comprising an attribute indicating a request for backup data.

14. The device of claim 13 wherein the OMA DM GET command furthermore comprises an indication of a requested number of backup nodes for which backup data is requested; and the restore means is arranged to retrieve backup data for the requested number of backup nodes being dependent on the first node.

15. The device of claim 1 wherein the restore means is arranged to restore at least part of a sub-tree of the OMA DM management tree having the first node as a root node in response to receiving an OMA DM REPLACE command specifying the first node and comprising an attribute indicating a request for restoring of the first node.

16. The device of claim 15 wherein the OMA DM REPLACE command furthermore comprises an indication of a requested number changes to be restored; and the restore means is arranged to retrieve backup data for the requested number of backup nodes being dependent on the first node and to restore the sub-tree in response to the requested number of backup nodes.

17. The device of claim 1 wherein the backup means is arranged to store backup data for a plurality of changes associated with the first node by adding a backup node for each change, the backup node of a previous change being a child node of a backup node for a subsequent change; and the restore means is arranged to restore the first node for a requested number of changes by sequentially restoring the first node in response to backup data of the requested number of dependent backup nodes.

18. The device of claim 1 wherein the device is a mobile phone.

19. A method of operation for a device, the method comprising:
providing an Open Mobile Alliance Device Management, OMA DM, management tree;
detecting a change associated with at least a first node of the management tree;
adding a first backup node as a child node of the first node in response to the detection of the change, the backup node comprising backup data representing a setting for the first node prior to the change; and
restoring at least part of the management tree to a setting prior to the change in response to a retrieval of the backup data from the first backup node.
